(19) United States
(12) Patent Application Publication
(10) Pub. No.: US 2013/0098780 A1
(43) Pub. Date: Apr. 25, 2013

(54) SENSING AND SENSORS

(71) Applicants: Pantelis Georgiou, Wembley Middlesex (GB); Themistoklis Prodromakis, London (GB); Timothy G. Constandinou, London (GB); Christofer Toumazou, London (GB)

(72) Inventors: Pantelis Georgiou, Wembley Middlesex (GB); Themistoklis Prodromakis, London (GB); Timothy G. Constandinou, London (GB); Christofer Toumazou, London (GB)

(73) Assignee: DNA Electronics Limited, London (GB)

(21) Appl. No.: 13/576,561

(22) PCT Filed: Jan. 28, 2011
(86) PCT No.: PCT/GB2011/050133

§ 371 Date: Aug. 1, 2012

(30) Foreign Application Priority Data
Feb. 3, 2010 (GB) 1001743.2

(51) Int. Cl. G01N 27/416

(52) U.S. Cl. CPC G01N 27/4163
USPC 205/792; 204/400; 204/403.01

(57) ABSTRACT

A sensor system comprising a substrate and integrated onto the substrate an array (7) of sensor elements (1), each sensor element comprising one or more inductors (3), one or more electrochemical sensors (4), and one or more optical sensors (2). The system further comprising a controller configured in use to separately address each of the sensor elements (1) to drive the respective inductors and receive outputs of the respective sensors.

### TECHNICAL FIELD

The present invention relates to a sensor system, a method of calibrating a sensor system, and a method of using a sensor system to observe biological or chemical activity.

### BACKGROUND

In the last decade, the relentless trend towards technology miniaturisation has facilitated new opportunities for microfluidic integration. Combined with modern microelectronics, this has opened up new paradigms for novel lab-on-chip platforms, miniaturising conventional analytical systems. As a result there has been a new drive to fabricate these using standard CMOS technologies due to overlapping requirements when combined with modern day chemical micro-sensing devices. These include miniaturisation of sensors, batch fabrication, integration of processing and signal conditioning circuitry and cheap cost of manufacture.

These enabling technologies have enabled spatiotemporal sensing and excitation of various physical and chemical parameters by exploiting parasitic devices. For example, CMOS-based imagers using parasitic pn-junction photodiodes have been developed into novel lab-on-chip platforms for applications in fluorometry to measure metabolic activity and viability of biological cells. Similarly, ISFET-based chemical sensors are becoming increasingly popular due to the fact that they can be fabricated in unmodified CMOS technology. These sensors can sense pH by exploiting the silicon nitride passivation which can be used as an sensing membrane. It has been shown how an array of ISFETs can be employed to form a chemical imager, acquiring a spatiotemporal map of chemical changes occurring at the surface of the CMOS die for applications of cell monitoring. Exploiting thick top metal process options adopted for RF applications, microcoils have also been applied to lab-on-chip platforms. Used in an array, these can generate a spatiotemporal magnetic field to manipulate biological cells that are attached on micro-beads.

It has been demonstrated that magnetic stimulation of neural tissue is possible by aid of eddy currents. However, problems with existing electrical stimulation include invasiveness, lack of biocompatibility and lack of bio-resistance matching. For example, Transcranial Magnetic Stimulation has been used for almost 25 years. And yet all systems presented to date make use of excessively large components. Additionally, the need of a system that can combine a TM stimulator and an appropriate monitoring scheme for recording neural activity before, during and after stimulation has not yet been satisfied.

Known methods for DNA and RNA measurement, either for genotyping, gene expression analysis or sequencing, or molecular diagnostics for pathogen identification, include the use of microarray technology, usually fabricated on a glass substrate, on to which between one and several hundred thousand nucleic acid different “probe” oligonucleotides are arranged in an array format, either through direct chemical linkage or to the substrate, or by attachment to beads, or by use of microchannels to create individual chambers for each type of probe. For reference, see “Highly Parallel Genomic Assays” (Nature Reviews August 2006) and “Exploring the new world of the genome with DNA microarrays” (Nature Reviews January 1999) for further discussion of this field. Examples of existing platforms include the Affymetrix GeneChip, the Illumine BeadChip, and the 454 Genome Analyzer. When the sample to be analysed and/or specific reagents and nucleotides are delivered to the microarray, hybridisation and/or nucleotide incorporation events are usually detected optically directly using fluorescent labels on one of the reaction components (e.g. probes, target, or nucleotides, depending on the application and the platform) or indirectly using enzymes which generate light as a consequence of the hybridisation or nucletide insertion events (e.g. pyrosequencing). In some microarray platforms (e.g. Osmetech eSensor), electrochemical labels are used and electrochemical signals are detected to infer hybridisation or nucleotide incorporation events. Further, it has been reported in UK patent application GB0105831 that label-free electrochemical detection of pH arising from nucleotide incorporation events can be used to sequence nucleic acid and/or genotype nucleic acid.

The following references provide background to sensor array structures, properties, and fabrication methods:

J. Bausells and J. Carrabina and A. Errachid and A. Merlos. Ion-sensitive field-effect transistors fabricated in a commercial CMOS technology. Sensors and Actuators B: Chemical, 57(1-3):56--62, 1999.

Georgiou, P. and Toumazou, C. An adaptive ISFET chemical imager chip. Circuits and Systems, 2008. ISCAS 2008. IEEE International Symposium on, :2078--2081, 2008.

Georgiou, P. and Toumazou, C. CMOS-based programmable gate ISFET. Electronics Letters, 44:1289, 2008.

Pantelis Georgiou and Christofer Toumazou. ISFET characteristics in CMOS and their application to weak inversion operation. Sensors and Actuators B: Chemical, In Press, Corrected Proof:-, 2009.

J. Janata, et al. Solid State Chem. Sensors. Academic Press, 1985.

Lee, H. and Liu, Y. and Westervelt, R. M. and Ham, D. IC/microfluidic hybrid system for magnetic manipulation of biological cells. IEEE Journal of Solid-State Circuits, 41(6):1471-1480, 2006.

N. Nelson, D. Sander, M. Dandin, S. B. Prakash, A. Sarje and P. Abshire. Handheld Fluorometers for Lab-on-a-Chip Applications. IEEE Trans. Biomedical Circuits and Systems, 3(2):97--107, 2009.

Prodromakis, T. and Georgiou, P. and Constandinou, T G and Michelakis, K. and Toumazou, C. Batch encapsulation technique for CMOS based chemical sensors. IEEE Biomedical Circuits and Systems Conference, 2008. BioCAS 2008, pages 321-324, 2008.

T. Prodromakis, K. Michelakis, T. Zoumpoulidis, R. Dekker and C. Toumazou. Biocompatible Encapsulation of CMOS based Chemical Sensors. IEEE Sensors, 2009.

### SUMMARY

The present inventors have appreciated that the combination of magnetic manipulation/stimulation, optical sensing and chemical sensing into a single pixel provides a sensor platform which can improve observation of some properties of enable new applications. For example some properties of a reaction or biological material can be detected optically but not chemically, and vice versa for other properties. In some cases, it is only when these properties are known together that one can draw conclusions about the state of the reaction or biological material.

Further advantages and applications can be realised by arranging these novel pixels into an array. For example this allows the whole of a sample or reaction to be considered and discrete parts compared spatiotemporally.

According to a first aspect of the invention there is provided a sensor system comprising a substrate integrated onto which are one or more inductance, one or more electrochemical sensor, and one or more optical sensor, and a circuit configured to drive the one or more inductance and configured to provide one or more output signals from the sensors.

According to a second aspect of the invention there is provided a method of observing biological or chemical activity and comprising providing a media to be observed adjacent a sensor or sensor system according to any preceding claim; influencing the media using the one or more inductance; comparing the electrochemical sensor output with the optical sensor output to determine one or more properties of the media.

According to a third aspect of the invention there is provided a method of calibrating a sensor system comprising reading a plurality of calibration values from a memory; using at least one calibration value per sensor to modify a property of each sensor, such that the sensor outputs of the sensor system achieves a desired state.

Further preferred aspects of the invention are set out in the accompanying dependent claims.

### BRIEF DESCRIPTION OF THE DRAWINGS

FIG. 1 is a microphotograph of an embodiment of (a) the sensor system and (b) a sensor pixel;

FIG. 2 is an illustration of the system architecture of an embodiment;

FIG. 3 is a schematic of a pixel control circuit;

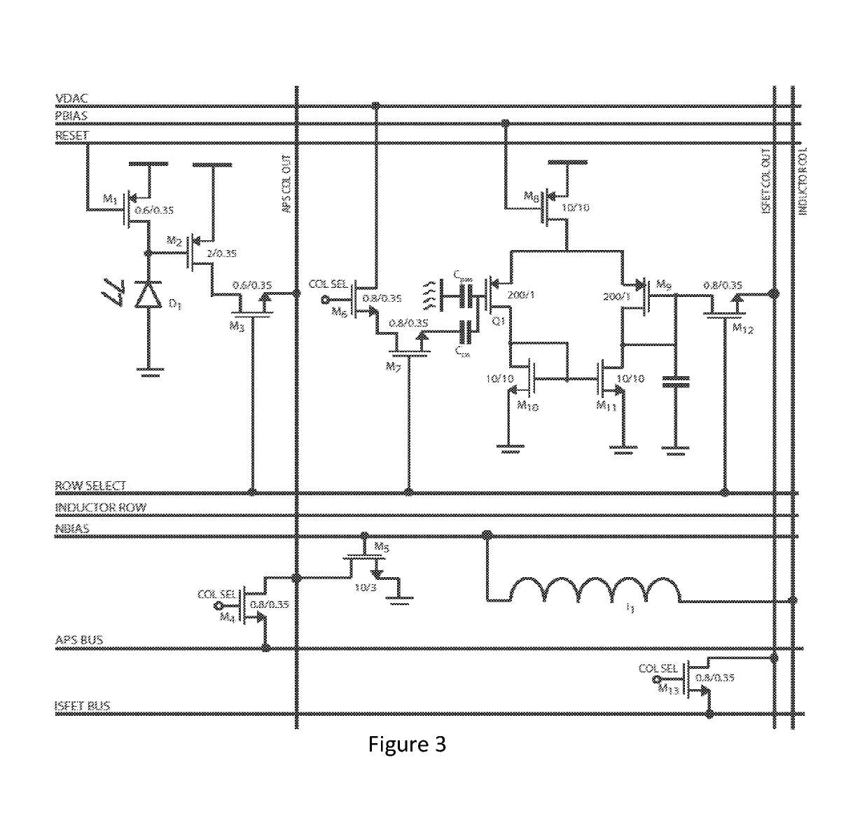

FIG. 4 is a timing diagram of input and output signals;

FIG. 5 is an illustration of a system having a microfluidic 8-lane channel for passing a sample over a sensor array;

FIG. 6 is an illustration of a system having a microfluidic meander channel for passing a sample over a sensor array;

### DETAILED DESCRIPTION

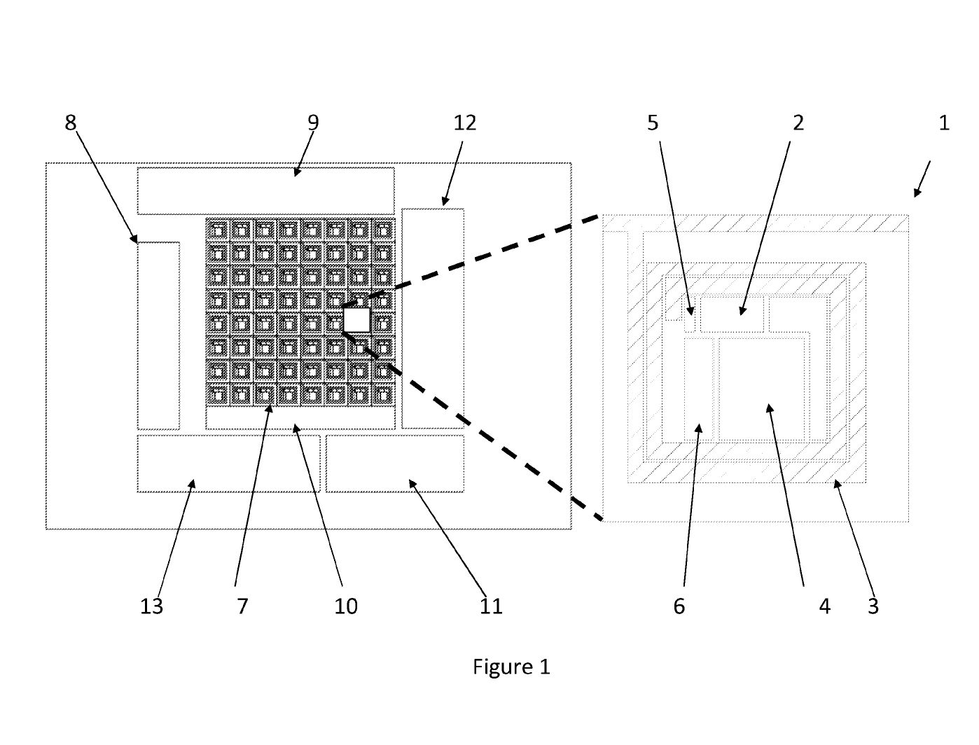

A preferred embodiment using an 8 pixel×8 pixel sensor system is shown in FIG. 1 and described below. The left hand portion of FIG. 1 indicates a system having an 8×8 pixel array 7 and devices to control and acquire date from the pixel array, such as: a RAM Bank (Rolling Buffer) 8, CDS Colum Buffers 10, a Data Conversion Interface 11, a Sensory Front End (for amplification) 12, and an Inductor Controller 9.

The embodiment provides a versatile platform for applications requiring magnetic manipulation of biological samples, such as cell movement, DNA hybridisation, extension and sequencing, as well as opto-chemical imaging of ongoing chemical reactions. Fabricated in a commercially available 0.35 μm CMOS process, the system is scaled to form an 8×8 array capable of calibrating out sensor non-idealities including drift, spatial (static) noise and gain mismatch. Furthermore, the system provides a programmable spatial field generator for magnetic manipulation. The system can be intrinsically used for both optical imaging and pH sensing

A sensor pixel is shown in the right hand portion of FIG. 1. As can be seen the sensor pixel has a photodiode 2 adjacent an ISFET 4, both surrounded by an inductor 3. In use, chemical or biological substances may be brought into proximity with the sensor surface, whereby a combination of magnetic stimulation and chemical and/or optical data can be used to determine a property of the substance.

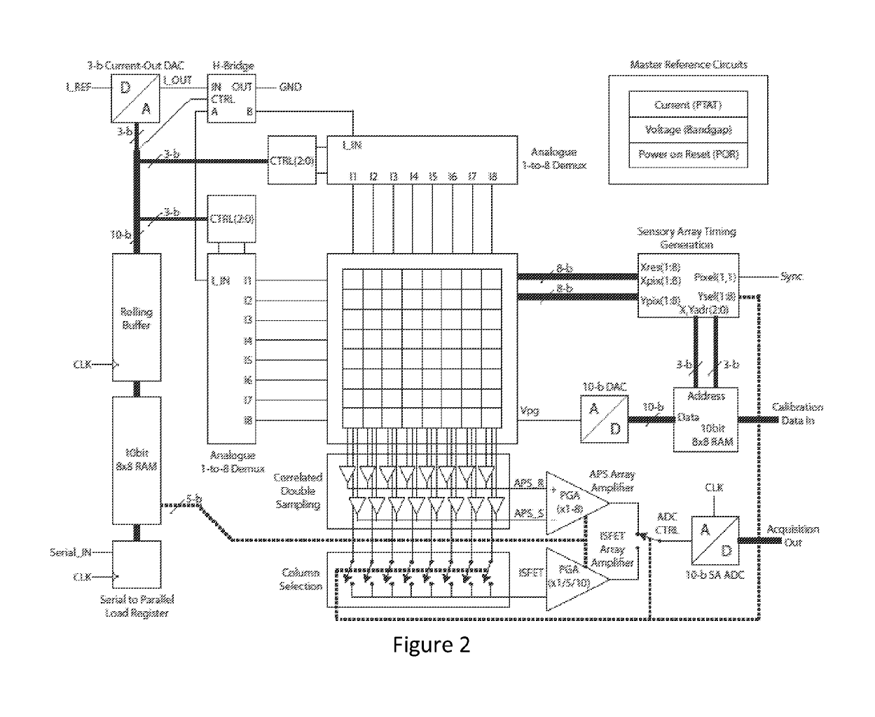

The top level system architecture is shown in FIG. 2. The array combines three sub-systems for sensory acquisition (i.e. optical and chemical imaging) and generation of magnetic stimulus. The system uses a common programming/calibration interface based on the SPI protocol to load data serially. This data includes 8×8×10-bit words for the chemical/optical calibration, 64 10-bit words to define the magnetic temporal pattern, and one additional word to control the amplifier gains. Master reference circuits are also common to the pixels, providing a 1 μA PTAT generated current bias, a 1.21V bandgap voltage reference, and power-on reset signals to the various circuits. The outputs are sampled using a single 10-bit successive approximation analogue-to-digital converter by interleaving the chemical and optical image data.

In one embodiment more than one electrochemical or more than one optical sensor is integrated into a single sensor pixel, the sensors preferably being designed to detect different properties or having different sensitivities. For example, there may be several optical sensors, each designed to detect different wavelength.

Magnetic Pattern Generator

The Magnetic Pattern Generator may be provided by a 64×10-bit rolling buffer that cycles a 10-bit instruction onto the magnetic controller. The 10-bit instruction is defined as follows: bits 9-7=x-coordinate, bits 6-4=y-coordinate, bit 3=polarity and bits 2-0=magnitude. The current is first generated using a 3-bit digital-to-analogue converter (based on a binary-weighted current mirror) and the polarity can then be reversed using a n H-bridge configuration. The coordinate bits are then used to control two demultiplexers (for X and Y) that current steer the generated stimulus towards the active pixel. The current passes through a microcoil that generates a magnetic field at the pixel, the strength decreasing rapidly at pixels further from the active pixel.

The magnetic manipulation of fluidic (e.g. biological) substances may be achieved by attaching magnetic micro-beads to components of the substance and then generating a large enough magnetic force to attract the micro-beads to a pixel. This magnetic trapping force [6] is given by:

$$\vec{F} = \frac{{v}_{x}}{{μ}_{o}} \cdot \vec{∇} {\vert B \vert}^{2} \qquad ( 1 )$$

where, V and X are the volume and magnetic susceptibility of the magnetic bead, μ₀ is the magnetic permeability in vacuum and B is the magnetic field magnitude. The micro-coil demonstrates a magnetic field distribution, dictated by the magnitude and direction of the biasing-current in accordance with the Biot-Savart law:

$$B = \int \frac{{μ}_{o}}{4 π} \frac{I d l r}{{r}^{s}} \qquad ( 2 )$$

where I is the current-bias, dl is a vector, whose magnitude is the length of the micro-coil windings, and whose direction is the same as l, and r is the displacement unit vector.

Sensor Array

A timing generator based on a state-machine first defines the different phases and array control signals (eg. x and y-pixel select signals) to poll through the sensory pixel array. The chemical pixel sensors are sampled during the second half clock period (during the phase a pixel is active) and the optical pixel sensors are sampled during the first half clock period (with one period latency-due to the correlated double sampling). The schematic of the integrated pixel is shown in FIG. 2.

Electro-Chemical Sensor

The electro-chemical sensor may be any sensor capable of measuring electrical or chemical property. In the present embodiment it is based on a PG-ISFET (programmable gate ion sensitive field effect transistor) chemical sensor that is biased using a unity-gain buffer interface at pixel-level. The outputs are switched (i.e. the rows are selected) into a shared column bus at the pixel level and output column selected at the column header. The output signal is then buffered through a Programmable Gain Amplifier (PGA) and passed to the converter for data acquisition.

The PG-ISFET floating gate voltage V_{FG} is established by a weighted sum of the voltages applied to the reference electrode (typically Ag/AgCl), through and the control gate, through V_{CG}:

$${V}_{FG} = \frac{{V}_{G 1} \cdot {C}_{pass} + {V}_{CG} \cdot {C}_{CG} + {V}_{S} \cdot {C}_{GS} + {V}_{D} \cdot {C}_{GD}}{{C}_{T}} \qquad ( 3 )$$

When the ISFET is biased, ions in solution bind to the passivation causing an accumulation of charge which in turn modulates the floating gate voltage of the device creating a dependance on pH according to:

$${V}_{G}^{′} = {V}_{ref} - {V}_{tc} - γ + \frac{2.3 α kT}{q} pH \qquad ( 4 )$$

Whereby V_{tc} is the non-ideal effects of trapped charge, V_{ref} is the bias voltage of the reference electrode, kT/q=Uₜ is the thermal voltage of the device (where k is the Boltzmann constant, T is temperature, and q is the magnitude of the electrical charge on an electron), Y is a grouping of pH-independent chemical potentials and α is a number ranging from 0-1, describing the reduction in sensitivity from the Nernstian response, typically 59 mV/pH at 25° C.

The programmable gate input is fed from a DAC to provide a variable gate bias. The bias is loaded at initialization from a RAM-based lookup table. This is implemented to calibrate and remove sensor non-idealities including drift, spatial (static) noise and gain mismatch.

The initial look-up table values can be determined by reading the sensor output of each sensor in a initial state. The initial state may be, for example, a control substance provided to the array or the absence of a sample on the array. The sensor outputs are then compared to a global parameter such as a normalised output voltage or some desired state. The gate bias voltage is then estimated (for example using equation 3) to establish the normalised output voltage or desired state. This measurement and calculation may be performed iteratively until the result is achieved.

One desired state may be that all the output voltages are the same in the absence of a sample. Another desired state may be that a predetermined output pattern is established. Yet another desired state may be that the sensors' non-idealities are minimised.

Prior to reading the sensor array, the look-up values are loaded to calibrate each sensor so that the sensor output voltages are more useful.

Optical Sensor

The optical sensor may implement a standard Active Pixel Sensor (APS) architecture utilising a standard 3-transistor pixel (x-reset, common drain buffer and y-switch). The APS Circuit 5 controls the photodiode 2 (See FIG. 1) The photodiode 2 is based on an n-well/p-substrate parasitic pn-junction of dimensions 16 μm×36 μm. The shared column bus lines are fed into column-level Correlated Double Sampling (CDS) buffers and differential signal switched (i.e. column selected) into an array-level difference amplifier (also a PGA for adjusting imager sensitivity).

Fabricated Platform

The sensor platform may be designed and fabricated in a commercially-available 0.35 μm CMOS technology. Using a four-metal layer process, a multi-layer spiral micro-coil can be implemented having 5 turns to achieve a higher magnetic field profile for the given biasing scheme.

A split padring may be implemented to achieve an isolated power supply for the analogue and digital sections. This allows for planar manipulation of the sensing surface, which allows subsequent post-processing for encapsulating the system.

Mircofluidic channels may be provided to the sensor array in order to bring the sample of interest into contact with the sensor pixels in a predefined pattern. The pattern of the channels will depend on the type of application. The channel may be fabricated using microfluidic dies based on Polydimethylsiloxane (PDMS) membranes, which are bonded to microscope glass slides with inlet and outlet capillaries via an plasma treatment. The channels may be photolithographically patterned on a 100 m thick negative photoresist (SU-8) layer, which is spin-coated on a Si-wafer and essentially serves as the mold for the PDMS casting. Other photo-curable material can be used to pattern channels on to the array.

Alternatively channels drilled or etched into a manifold sealed to the chip surface could be used.

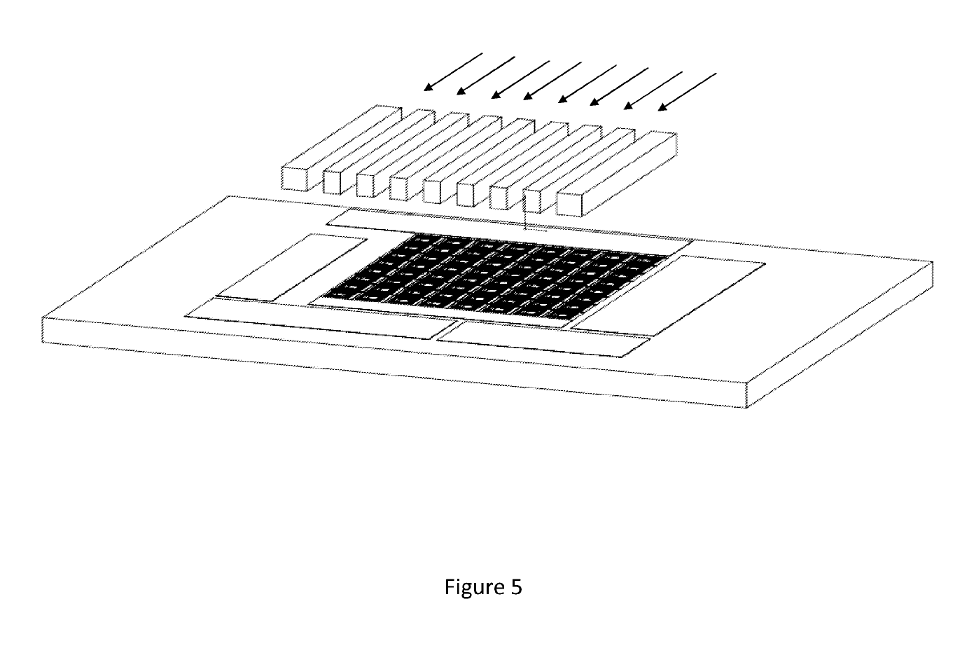

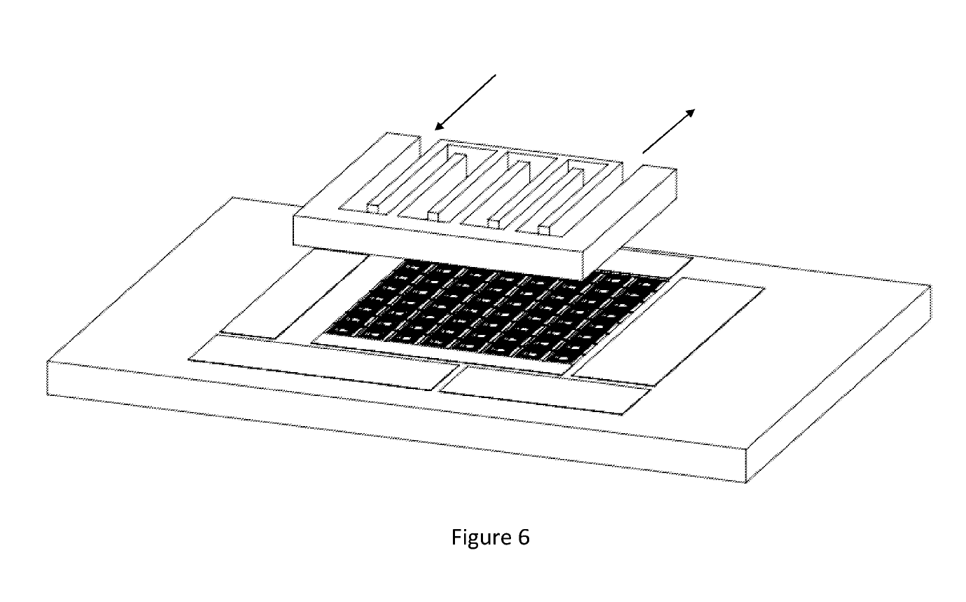

The sample may be subject to reagents/treatments before entering the channel or may encounter reagents/treatments as it passes over the sensor array. FIG. 6 illustrates a meander channel which allows a single sample to flow past all pixels in the array. FIG. 5 illustrates an 8-lane channel which allows eight samples to flow past columns of pixels in the array. The sample may be manipulated and measured at different pixels and at different times to generate a spatiotemporal understanding of the reaction.

Simulated Results

The circuit was simulated using the Cadence Spectre (5.1.41isr1) simulator with foundry supplied BSIM3 models.

Transient Circuit Simulation

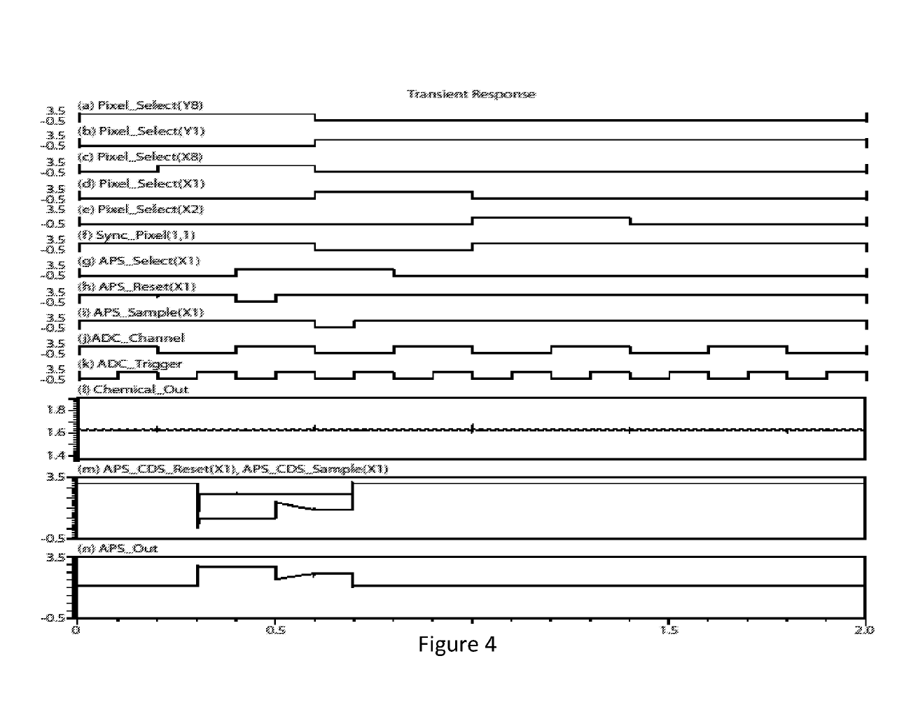

Transient simulation results illustrating the timing controller for the sensor array, imager (i.e. chemical and optical) outputs and acquisition timing are shown in FIG. 4. This simulation shows the timing and sensory acquisition cycle from pixel (8,8) bottom-right through pixel (1,1) to pixel (3,1). Below this is shown the output of the ISFET bus before and after the PGA stage for two rows of different simulated sinusoidal pH responses. A reference electrode voltage of 3.3V and control gate voltage of 1V is used to program the pixels to be mid range of the supply to maximise the ND resolution. In FIG. 4, the output of the CDS bus (reset and sample lines) and the array output after the PGA stage can be seen.

Electromagnetic Simulation

Consider the magnetic field distribution on the Si₃N₄ passivation layer above the 8×8 array, when the micro-coil of pixel (1,1) is biased with I=20 mA. Although there is coupling between adjacent pixels, a single excitation is not strong enough to distract micro-bead movement. Specifically, in the vicinity of the biased pixel, the magnetic field strength is approximately 17 G which decays to 1 G in the neighbouring pixels and 1 mG at the far corner of the array.

Measurement of Neural Activity

Whilst known methods of transcranial magnetic stimulation (TMS) utilize arrays of large coils to stimulate and measure neural activity, the embodiment described below may provide for detection of neural activity at a much smaller scale.

A sensor array may be used to measure with the may be used to observe neural activity in neural tissue. In particular, neural action potentials may be sensed through electrostatic coupling between a neuron and the floating gate of the ISFET. This allows applications such as determining if a neuron is active. For example, neurons may be grown on a sensor array. The electrochemical output from a pixel can be compared to the optical sensor output. If a neuron's existance can be confirmed optically but not detected chemically, one might conclude that the neuron is ‘dead’.

Using CMOS technology, exploiting thick top metal process options adopted for RF applications, microcoils can be provided on sensor platforms. Used in an array, these microcoils can generate a spatiotemporal magnetic field to facilitate neural stimulation at a micro scale.

Suitable embodiments of the above described sensor array may be used to provide non-contact interfacing to neural tissue using magnetic stimulation combined with electrochemical and optical sensing.

The magnetic stimulation of neural tissue is achieved by employing a large enough field from the micro-coils to evoke action potentials in the neurons. Appropriate biasing of the micro-coils will cause a varying magnetic field that in turn causes circulating eddy currents within the substance attached to the coils. The strength of these currents is typically calculated through the encountered loss, which under the assumptions of a uniform material and magnetic field distribution can be expressed as:

$$P = \frac{{π}^{2} {B}^{2} {d}^{2} {f}^{2}}{6 ρ D} \qquad ( 5 )$$

where d is the thickness of the medium in which the eddy currents are deployed, f is the frequency of magnetic field change, ρ is the resistivity, and D is the density of the material.

The ISFET may be used in this application as a neurochemical sensor. When the ISFET is biased, action potentials evoked from neural tissue on the surface cause a change in the charge distribution, which in turn modulates the floating gate voltage of the device creating according to:

V_{G}¹=V_{ref}−V_{tc}−Vₙₑᵤᵣₒ (6)

Whereby V_{tc} is the non-ideal effects of trapped charge, V_{ref} is the bias voltage of the reference electrode, and Vₙₑᵤᵣₒ is the contribution of the evoked action potential.

Electromagnetic Simulation

An added benefit of the array comes with applications that necessitate the combined use of inductive elements with beam-forming algorithms for attaining multiple neuron stimulation or single neurons that exist in deeper regions of the brain.

Embodiments of a neural sensing system can accommodate a time-varying magnetic field by programming individual pixel biases as a sequence of current pulses of various amplitudes and pulse duration. Depending on the magnetic field distribution, a number of eddy currents will be circulated within the neural tissue that is in direct contact with the platform's surface. Based on the strength of these currents (equation 2) neuron activation may occur, which will result in the release of ions (for example, neurotransmitters) that will be subsequently sensed by the ISFETs. There is thus potential to use this platform with brain slice applications, where smaller field intensities are required.

When compared with traditional electrical stimulation, this method provides certain advantages such as non-invasiveness, improved biocompatibility and bio-resistance matching. The lack of a metal-electrolyte interface, which often posses challenges such as modification of the electrode surface, corrosion and bio-fouling is alleviated, resulting in improved robustness and system stability. Recent advancements in transcranial magnetic stimulation (TMS) utilize arrays of coils, which offer the added benefits of spatial-temporal in addition to focused magnetic stimulation.

It will be apparent to the skilled person that the sensor and array may be modified beyond what has be described above by way of example. For example, the array may extend in one dimension or two and contain as many sensor pixels as is desired for the application. An electrochemical sensor, other than an ISFET, may be employed such as capacitive, potentiometric, amperometric, chemiresistive or other technologies as they develop. Similarly, different optical sensors may be used. Preferably the sensors are solid state and capable of being integrated into a semiconductor chip. Furthermore, resistive or other types of heating element may be included within the array, as well as temperature sensors provided by diodes, resistors or temperature-sensitive circuits, for applications requiring thermal control or heating.

Measurement and Analysis and Sequencing of Nucleic Acid

The inventors have appreciated that prior array-based methods for nucleic acid analysis are lab intensive requiring skilled personnel and excessive steps to prepare and process the sample. These methods also suffer from read errors such as false positive and false negative results.

The advantage of an array combining several sensors over existing microarray techniques is the combination of electrical, optical and electromagnetic capability to provide flexibility and a universal platform for multiple applications, including multiple, multianalyte arrays combining one or more of DNA, RNA, protein, enzyme or chemical compound detection, all of which can be detected optically or electrochemically, or by changes in resonant frequency of DNA attached to a magnetic bead or temperature. The ability to magnetically stimulate specific locations or regions of the array gives the additional ability to move reagents or target which are attached to beads, which is a significant advance automation and usability and allows assays steps which would normally have to be performed offline prior to introduction to the array, to happen on-chip. Examples of such assay steps include mixing, bead capture during washing, and selective movement of certain reagents within the array. The ability to automate in this way makes this a platform suitable for use outside a laboratory, potentially removing the need for cumbersome off-chip sample preparation, nucleic acid extraction and amplification steps.

A further benefit is the increased signal-to-noise potential provided. For example, the ability to perform orthogonal measurements on a single target using both fluorescent and electrochemcial signals. Furthermore, the optical and electrochemical signals can be correlated, and used to reduce the rate of false positives or false negatives if there is not good correlation between the two signals. Another way of reducing detection errors in an assay performed on the array described herein is to use the photodiodes as a form of quality control in an electrochemical assay, and to discard results for electrochemical sensors in the array where there is for example, non-uniform mixing of sample, bubbles, clogging of microchannels or reaction chambers, misalignment, or other non-ideal assay conditions which can be observed optically. Furthermore, in assays where uniform reagent distribution or uniform “packing density” of beads is required, this can be observed optically. The design specification of a preferred embodiment of the sensor platform are given in Table 1.

TABLE 1
Sensor Specifications

| | |
|---|---|
| Technology, Supply voltage | 0.35 μm 2P4M CMOS, 3.3 V |

Optical Sensing

| | |
|---|---|
| Sensing area, fill factor | 576 μm, 2.56% |
| Optical dark current | 2.4 fA |
| Frame rate | 25-200 FPS |
| Photocurrent (at 1.5 W/m²) | 375 pA (responsivity of 0.4 A/W) |

Chemical Sensing

| | |
|---|---|
| Sensing area, fill factor | 2500 μm, 11.1% |
| Sense resolution, range | 0.01 pH, 2-12 pH |
| Frame rate | <25 FPS |
| Vt-calibration range | ±6 V (10 bit tuning) |

Magnetic Excitation

| | |
|---|---|
| Coil turns (M1 to M4) | 5 |
| Equivalent Inductance | 111.4 nH |
| Instruction memory | 64 × 10-bit |
| Minimum instruction period | 150 μs |
| Maximum excitation current | 27 mA† |
| Maximum magnetic flux density | 1.5 mT |
| Die dimensions | 2895 μm × 2155 μm |
| System device count | 57,784 |
| Array size | 8 × 8 pixels |
| ADC res., conversion time | 10-bit, 10 μs |

†Limited by metal current density (1 mA/μm)

1. A sensor system comprising a substrate and, integrated onto the substrate, a sensor element, the sensor element comprising one or more inductors, one or more electrochemical sensors, and one or more optical sensors, the sensor system further comprising a controller configured in use to drive the one or more inductors and to monitor outputs of the sensors in order to provide a sensor element result.

2. A sensor system according to claim 1 and comprising an array of said sensor elements, said controller being configured in user to separately drive the inductors and monitor the sensors of each sensor element.

3. A sensor system according to claim 1, wherein the sensor elements are fabricated using a CMOS process.

4. A sensor system according to claim 1, wherein the one or more inductors are microcoils.

5. A sensor system according to claim 4, wherein the sensors of each sensor element are located substantially within each associated inductor microcoil.

6. A sensor system according to claim 1, further comprising a structure defining channels arranged to control the flow of media across the sensor elements.

7. A sensor system according to claim 1, further comprising a structure defining wells on top of the sensor elements for separating groups of media.

8. A method of observing biological or chemical activity comprising providing a sample to be observed on or adjacent to a sensor system having a sensor system comprising a substrate and, integrated onto the substrate, a sensor element, the sensor element comprising one or more inductors, one or more electrochemical sensors, and one or more optical sensors, the sensor system further comprising a controller configured in use to drive the one or more inductors and to monitor outputs of the sensors in order to provide a sensor element result; and,
influencing, for each sensor element, the sample using the one or more inductors and observing the electrochemical sensor output with the optical sensor output to determine one or more properties of the sample.

9. A method according to claim 8, wherein said sample is neural tissue and the activity is neural activity, the electrochemical sensor output corresponding to ions released from neurons, preferably corresponding to neurotransmitters released.

10. A method according to claim 9, wherein the or each inductor provides stimulation of one or more neurons.

11. A method according to claim 9 or 10, wherein one or more neurons are targeted by beam forming using a plurality of inductors.

12. A method according to claim 8, wherein the activity is a chemical reaction and the electrochemical sensor output corresponds to reaction intermediaries.

13. A method according to claim 8, wherein the activity corresponds to the insertion of one or more nucleotides at the end of a nucleotide chain.

14. A method according to claim 8, further comprising manipulating the sample using the one or more inductors.

15. A method according to claim 8, further comprising stimulating the media using the one or more inductors.

16. A method of calibrating a sensor system according to claim 8, further comprising reading a plurality of calibration values from a memory, using at least one calibration value per sensor element to modify a property of each sensor element, such that the sensor element outputs of the sensor system achieve a desired state.

17. A method according to claim 16, further comprising calculating the calibration values by comparing each sensor output in an initial state with a global parameter and then storing the calibration value in the memory.

18. A method according to claim 16, wherein the calculation of the calibration value is performed iteratively.

19. A method according to anyone of claims 16, wherein the calibration value determines a gate bias voltage of an ISFET of each sensor element.

20. A method according to claim 16, wherein the desired state is minimised mismatch between sensor output in the array.

21. A method according to claim 16, wherein the desired state is minimized sensor non-ideality.

22. A method according to claim 8, further comprising analyzing an output of an optical sensor of the or each sensor element to identify the presence of a sample on or adjacent to the optical sensor.

23. A sensor system comprising a substrate and integrated onto the substrate an array of sensor elements, each sensor element comprising:
one or more inductors;
one or more electrochemical sensors; and
one or more optical sensors, the system further comprising a controller configured in use to separately address each of the sensor elements to drive the respective inductors and receive outputs of the respective sensors.

24. A sensor system according to claim 23 and comprising one or more guide channels for guiding a sample to be analyzed across respective sensing surfaces of the sensor elements.

25. A sensor system according to claim 24, wherein each guide channel is integrated onto the substrate.

26. A sensor system according to claim 23 suitable for monitoring or conducting tests on one of a biological and biochemical sample.
